(19) United States
(12) Patent Application Publication
(10) Pub. No.: US 2022/0378100 A1
(43) Pub. Date: Dec. 1, 2022

(54) An Aerosol-Generating Article in Form of a Disposable Shaped Cartridge Comprising a Foamed Aerosol-Generating Material

(71) Applicant: JT International SA, Geneva (CH)

(72) Inventors: Anthony Dylan-Hyde, Annecy (FR); Theo Verlaan, Genève (CH)

(73) Assignee: JT International SA, Geneva (CH)

(21) Appl. No.: 17/769,950

(22) PCT Filed: Oct. 29, 2020
(86) PCT No.: PCT/EP2020/080455

§ 371 Date: Apr. 18, 2022

(30) Foreign Application Priority Data
Oct. 31, 2019 (EP) 19206433.5

(51) Int. Cl. A24F 40/42; A24F 40/20; A24F 40/46; A24F 40/48; A24F 40/30

(52) U.S. Cl. CPC A24F 40/42; A24F 40/20; A24F 40/46; A24F 40/48; A24F 40/30

(57) ABSTRACT

The present invention relates to an aerosol-generating article comprising a disposable shaped cartridge and a foamed aerosol-generating material provided in the cartridge, wherein the disposable shaped cartridge comprises a base, a top, an internal wall and an external wall, wherein the base and the top of the cartridge are connected to the internal wall and the external wall, wherein the internal wall is provided to form one or more longitudinal channels void of and extending through the foamed aerosol-generating material.

### TECHNICAL FIELD OF THE INVENTION

The present invention relates to the field of tobacco and vaping products, especially to aerosol-generating systems, comprising an aerosol-generating article in form of a shaped cartridge, comprising aerosol-generating materials contained in the disposable shaped cartridge. The invention also relates to the use of an aerosol-generating article comprising a disposable shaped cartridge in an aerosol-generating system, the disposable cartridge contains a foam-like aerosol-generating tobacco containing material.

### BACKGROUND OF THE INVENTION

Aerosol-generating devices in which an aerosol-forming, tobacco containing consumable, comprising a tobacco-containing material, usually formed of laminate sheets of reconstituted tobacco aggregated wound or generally collated together in a stick form, is heated rather than combusted are already known in the art. Such aerosol-generating devices are generically named as “Heat-not-burn” (HNB) devices and so are corresponding consumable sticks to be used therewith. They use a heater arrangement to heat the aerosol-generating material in stick format above 300 degrees Celsius to produce a nicotine-containing aerosol.

Existing HNB consumables may also comprise, instead of laminated sheets, foamed tobacco substrates. Manufacturing processes usually involve forming reconstituted tobacco sheets out of finely ground tobacco particles with a foam forming and a foam stabilizing agent, followed by shredding the reconstituted sheets, and blending with natural tobacco shreds. These foams are intended for use by combustion as a replacement for tobacco using reconstituted tobacco.

Existing vaping system including heat-not-burn aerosol-generating materials and articles are becoming increasingly popular but consumers at the same time acknowledge that they do not offer a comparable taste and sensory experience to conventional smoking articles such as cigarettes or cigars. In particular, consumers find currently available products to lack real tobacco taste.

It would thus be advantageous to provide consumers with aerosol-generating articles and materials providing a more pleasant taste experience, closer to real tobacco and easy to smoke (to draw air for inhale) that requires less inhaling effort for aerosol generation for consumption.

### SUMMARY OF THE INVENTION

The inventors of the present invention have found solutions to the above-discussed problems through a new and inventive aerosol-generating article as defined in the claims.

A first aspect of the invention is accordingly to provide an aerosol-generating article in form of a shaped cartridge comprising a foamed aerosol-generating material, wherein the shaped cartridge is disposable and comprises a base, a top, an internal wall and an external wall, wherein the base and the top of the cartridge are connected to the internal wall and the external wall, wherein the internal wall is provided to form one or more longitudinal channels void of and extending through the foamed aerosol-generating material.

A second aspect of the invention relates to an aerosol-generating system, comprising the aerosol-generating article in form of a shaped cartridge according to the present invention and an aerosol-generating device vaping device comprising a heating-generating element configured to fit within the one or more longitudinal channels within the cartridge of the aerosol-generating article.

A third aspect of the invention relates to the use of the aerosol-generating article in form of a shaped cartridge according to the present invention.

Thanks to the novel aerosol-generating article as explained herein, the efficiency of conveying heat from the heater of a heating device to a foam-like (mousse) material i.e. aerosol-generating substrate (or material) contained in a disposable shaped cartridge is improved as the aerosol-generating substrate is heated evenly, and not only restricted to certain location of the cartridge (e.g. regions around the heat-generating element). This in turn gives a denser, homogenised and more consistent aerosol from a single consumable, thus maximising the utility of the cartridge/capsule of the aerosol-generating substrates.

To this end, it is emphasized that the term “cartridge” can be used interchangeably with terms such as “capsule” and “container”. It is disclosed herein that in order to maximising the usage of the foamed aerosol-generating material of the capsule, the longitudinal channels are essential to be provided within the cartridge that are preferably extended from a proximal end to an opposite distal end, or preferably the channels are curved or spirals to increase the contact surface with the foamed aerosol-generating material.

In addition, heated air can also travel deeper into the cartridge, thereby producing a denser, more consistent aerosol which gives more pleasant experience.

In one embodiment, the one or more longitudinal channels extend from the base of the cartridge to the top and/or to the external wall of the cartridge. It has been found out that when the longitudinal channels extend from the base to the top of the cartridge, the heat from a heat-generating element can be transferred reaching the entire height of the cartridge, thus heating evenly the entire volume of the material in the cartridge. When the longitudinal channels extend from the base to the external wall of the cartridge, the heat from the heat-generating element can be channelled to the side of the cartridge, thus increasing the efficiency of the air circulation.

To this end, it can be foreseen that one or more longitudinal channels can be provided to the shaped cartridge, as well as that the longitudinal channels may be branched in order to increase the efficiency of heating the contents of the cartridge e.g. aerosol-generating material, tobacco-containing material, as well as to increase air flow circulation.

In another embodiment, the one or more longitudinal channels extend predominantly parallel to a longitudinal axis of the cartridge. This embodiment is the most efficient as aerosol-generating substrates e.g. foam-like or mousse material contained within the cartridge can be evenly heated from region close to the heat-generating element to the far side of the cartridge, while an air channel is created in the middle. In other words, the disposable shaped cartridge may resemble a doughnut shape cartridge, wherein air flows through the middle.

According to one embodiment, the one or more longitudinal channels are configured to accept a heat-generating element of a heating device. The shaped cartridge is designed to have a shape complementary to the heat-generating element such as to increase contact points. This embodiment has the advantage to help heating homogeneously the content of the cartridge, thereby generating a denser and more consistent aerosol.

According to yet another embodiment, the one or more longitudinal channels are straight or spiral shaped. A straight channel allows a simple disposable shaped cartridge to be produced while a spiral channel allows higher volume content of the cartridge to be heated e.g. by the heat-generating element or the heated air.

According to a further embodiment, the cross-section perpendicular to the longitudinal axis of the one or more longitudinal channels comprises a circular, edged, oval or irregular profile. These profiles are especially suitable to be provided at the region where the shaped cartridge contacts with the heat-generating element e.g. at the bottom or side of the cartridge, wherein these profiles are complementary to the surface profile of the heat-generating element such as to increase the contact points for an efficient heat transfer.

In a further embodiment, the cross-section perpendicular to the external wall of the cartridge has a circular, square, rectangular, triangular, ridge or spoke, polygon or an irregular shape. These profiles are especially suitable to be customised according to the shape of an aerosol-generating device.

In one particularly preferred embodiment, the base of the cartridge is substantially flat and/or edged such as to increase the contact points with a heat-generating element of a heating device. When the base of the cartridge is flat and/or its corners are edged (instead of round or oval edge), this increases the contact points between the cartridge and the heat-generating element.

In another preferred embodiment, the base of the cartridge has a surface complimentary to the shape of a heat-generating element of a heating device such as to increase the contact points between the base and the heat-generating element for the transmission of heat to the cartridge. The higher surface contact points allows more of the content of the cartridge to be heated, thereby generating denser and consistent taste.

According to another embodiment, the base, when viewed from a longitudinal section of the cartridge perpendicular to a horizontal plane of the cartridge, has one or more of the following shapes: V, N, U, n, A and w. These profiles increase the contact surface, thereby increasing heat transfer efficiency from the heat-generating element to the content of the cartridge.

According to one preferred embodiment, the cartridge is made of a temperature-resistant polymeric foam material. The cartridge may be made of elastic and deformable material.

In another embodiment, one or more openings are provided to the cartridge for filling of materials such as the aerosol-generating tobacco-containing substrates and/or carrier matrix. The opening may be provided on top and/or side of the cartridge (when in use). Of course, the opening may also be provided at any other location.

According to another embodiment, the shaped cartridge is air permeable and/or has a mesh structure.

According to a preferred embodiment, one or more individual compartments are provided to the cartridge, wherein the compartments are filled with same or different materials, comprising aerosol-generating tobacco-containing substrate and/or a stiff carrier matrix.

According to some further variants, between 10% and 33% of the total volume of the cartridge is comprised of longitudinal channels which are void of the foamed aerosol-generating material. These values ensures that sufficient amount of volumes of channels are disposed within the cartridge to have an optimal contact surface with the foamed aerosol-generating material so that almost the entire foamed aerosol-generating material can be used up to release the aerosol. Preferably, at least 5

By “about” or “approximately” in relation to a given numerical value, it is meant to include numerical values within 10% of the specified value. All values given in the present disclosure are to be understood to be complemented by the word “about”, unless it is clear to the contrary from the context.

The indefinite article “a” or “an” does not exclude a plurality, thus should be treated broadly.

Unless defined otherwise, technical and scientific terms used herein have the same meaning as commonly understood by one of ordinary skill in the art to which this invention belongs.

As used herein, the term “longitudinal” refers to the direction corresponding to the main longitudinal axis of the cartridge i.e. sagittal plane, which extends between the top and bottom of the cartridge. During use, air is drawn through the disposable shaped cartridge in the longitudinal direction i.e. from the base to the top or side of the cartridge, either straight up or spirally up of the channel or chimney. The term “transverse” refers to the direction that is perpendicular to the longitudinal axis.

Any reference to the “cross sectional” of the disposable shaped cartridge refers to the sagittal cross-section unless stated otherwise.

A tobacco-containing material can be any compound, mixture, particle matter, and/or solution that contains and/or carries a constituent of tobacco, either artificially included or naturally contained in tobacco, e.g. tobacco, tobacco particles, tobacco flavor and/or nicotine. In contrast, an example for an artificially added non-tobacco-specific flavor would be menthol.

As used herein, the term “aerosol-generating article” refers to an aerosol-generating article for producing an aerosol comprising an aerosol-generating material that is intended to be heated rather than combusted in order to release volatile compounds that can form an aerosol. For instance, the aerosol-generating article according to the present invention is provided in form of a cartridge so that foamed aerosol-generating materials are contained therein. The aerosol-generating article may comprise other components connected to the cartridge e.g. a mouthpiece, a filter and etc.

As used herein, the term “aerosol-generating material” refers to a material capable of releasing upon heating volatile compounds, which can form an aerosol. The aerosol generated from aerosol-generating material of aerosol-generating articles described herein may be visible or invisible and may include vapours (for example, fine particles of substances, which are in a gaseous state, that are ordinarily liquid or solid at room temperature) as well as gases and liquid droplets of condensed vapours. The material may or may not comprise tobacco-containing materials or substrates.

An aerosol-forming agent can be any compound, mixture and/or solution that is capable of forming an aerosol, e.g. when heated and/or in mixture with a tobacco ingredient containing agent. Well known examples include humectants such as glycerin and propylene glycol, other alcohols, such as ethanol, etc.

The term “foam” as used herein equates to “mousse” which relates to open pored substantially solid, i.e. non-fluid material capable of maintaining its shape and integrity absent external forces applied to the material except its own weight. The “foam” may be considered as being formed of a plurality of interconnecting pores (formed out of a structural material derived from the foam forming agent cooperating with the interacting components such as the foam stabilizing agent, solid components such as tobacco particles and some solvent, etc.) which are able to contain fluid, in particular a mixture of humectant/liquid aerosol-forming substrate and air.

An electronic cigarette (e-cigarette) or similar devices like electronic pipes or heat-not-burn devices, as referred to in the present invention, are not particularly limited, and may be used to provide a user with an aerosol to inhale. It can, according to certain embodiments, comprise a mouthpiece, a heater, a receiving portion, e.g. a pod, stick, capsule and a casing.

As used herein, vol. % is to be understood as volume percent, based on the total volume of the foam, unless explicitly otherwise specified. In the present disclosure, all amounts given in vol. % in a particular foam add up to 100 vol. % The volume percent are thereby calculated by dividing the volume of each component by the total volume of the foam, unless indicated otherwise or clear from context.

As used herein, wt.-% is to be understood as weight percent, based on the total weight of the substance, unless explicitly otherwise specified. In the present disclosure, all amounts are given in wt.-%, unless clearly stated otherwise or obvious from context. In the present disclosure, furthermore all amounts given in wt.-% add up to 100 wt.-%. The weight percent are thereby calculated by dividing the mass of each component by the total mass e.g. of the foam, unless indicated otherwise or clear from context.

The term “disposable” refers to a product that is designed with the intention to be thrown away after use, regardless of whether after a single use or after multiple use. The disposable cartridge in the present context is a cartridge intended to be thrown away after use.

The term “cartridge” refers to a hollow object, such as a box, that can be used for holding something, especially to carry or store it. It can also refer to a cartridge or a container which does not necessarily be made of a separate element to contain the materials therein such as the aerosol-generating material. The cartridge according to the present invention can also be made up of the aerosol-generating tobacco-containing substrates such as tobacco mousse i.e. the cartridge is made up of the mousse material. The mousse for example can have different kinds of constitution and textures such as cork-like (relatively stiff) or of more airy consistency (relatively spongy).

The term “longitudinal channel” refers to a passage where the main stream smoke flows from one end to another end of the longitudinal channel of the shaped cartridge, for instance from the base to the top of the cartridge, and vice versa. The channel serves as a passageway for heated air to travel as well as for accepting the heat-generating element of the heating device.

### BRIEF DESCRIPTION OF THE FIGURES

FIG. 1 is a schematic perspective view of the aerosol-generating article in form of a disposable shaped cartridge of a first embodiment of the present invention.

FIG. 2a is a schematic perspective view of the aerosol-generating article in form of a disposable shaped cartridge of a second embodiment of the present invention.

FIG. 2b is a schematic perspective see-through view of the aerosol-generating article in form of a disposable shaped cartridge according to the second embodiment of the present invention.

FIG. 3a is a schematic perspective see-through view of the aerosol-generating article in form of a disposable shaped cartridge according to a third embodiment of the present invention.

FIG. 3b is a schematic sagittal cross-sectional perspective view of the aerosol-generating article in form of a disposable shaped cartridge according to the third embodiment of the present invention.

FIG. 3c is a schematic sagittal cross-sectional view of the aerosol-generating article in form of a disposable shaped cartridge according to the third embodiment of the present invention.

FIG. 4a is a sagittal cross-sectional perspective view of the aerosol-generating article in form of a disposable shaped cartridge according to the fourth embodiment of the present invention.

FIG. 4b is a schematic sagittal cross-sectional view of the aerosol-generating article in form of a disposable shaped cartridge according to the fourth embodiment of the present invention.

FIG. 5a is a sagittal cross-sectional perspective view of the aerosol-generating article in form of a disposable shaped cartridge according to the fifth embodiment of the present invention.

FIG. 5b is schematic top view of the aerosol-generating article in form of a disposable shaped cartridge according to the fifth embodiment of the present invention.

FIG. 6a is a schematic perspective view of the aerosol-generating article in form of a disposable shaped cartridge according to the sixth embodiment of the present invention.

FIG. 6b is a schematic perspective see-through view of the aerosol-generating article in form of a disposable shaped cartridge according to the sixth embodiment of the present invention.

FIG. 6c is a schematic sagittal cross-sectional view of the aerosol-generating article in form of a disposable shaped cartridge according to the sixth embodiment of the present invention.

FIG. 7a is a schematic perspective view of the aerosol-generating article in form of a disposable shaped cartridge according to the seventh embodiment of the present invention.

FIG. 7b is a schematic frontal view of the aerosol-generating article in form of a disposable shaped cartridge according to the seventh embodiment of the present invention.

FIG. 8a is a schematic perspective view of the aerosol-generating article in form of a disposable shaped cartridge according to the eighth embodiment of the present invention.

FIG. 8b is a schematic frontal view of the aerosol-generating article in form of a disposable shaped cartridge according to the eighth embodiment of the present invention.

### DETAILED DESCRIPTION OF THE INVENTION

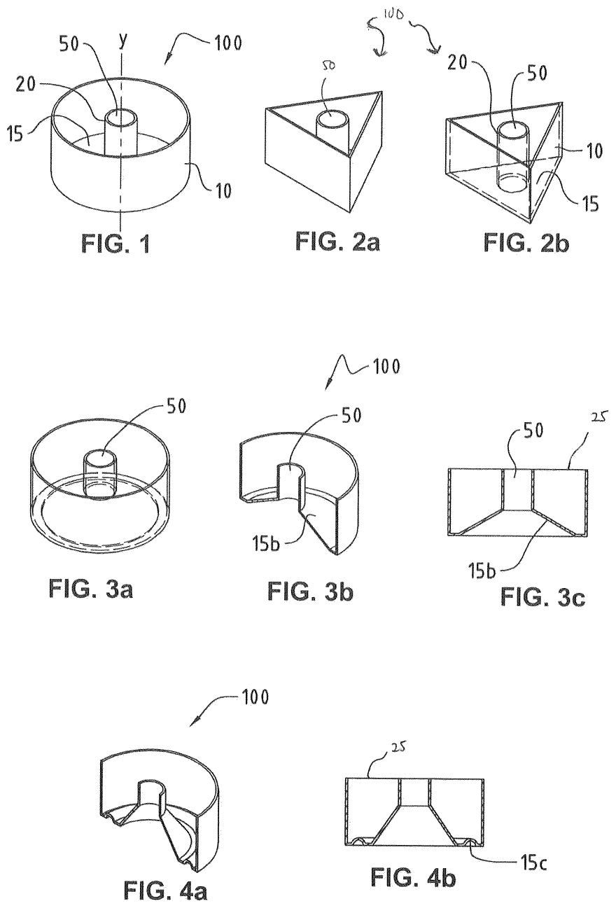

FIG. 1 shows an exemplary embodiment of an aerosol-generating article 100 in form of a disposable shaped cartridge according to the present invention. The disposable shaped cartridge is predominantly of cylindrical shape. For a simpler and clearer illustration, the top layer 25 (cf. FIGS. 3c, 4b and 8b) of the cartridge of all figures illustrated herein is removed such that the longitudinal channel(s) 50 of the disposable shaped cartridge can be seen.

As shown in the FIG. 1, the internal wall 20 is provided to form one longitudinal channel 50. The longitudinal channel 50 is parallel to the vertical axis (longitudinal axis Y) of the cartridge. The longitudinal channel 50 extends from the base 15 of the cartridge to the top 25 of the aerosol-generating article 100 in form of a cartridge.

The ratio of the diameters of the longitudinal channel to the cylindrical cartridge of all embodiments can be provided between 1:30 and 1:2, preferably between 1:20 and 1:3 or 1:10 and 1:4, most preferably 1:5. The height of the cartridge can be provided in between 10 mm and 100 mm, preferably between 15 mm and 50 mm, most preferably around 25 mm.

The disposable shaped cartridge according to the present invention can be made of heat-resistant polymeric material. These heat-resistant polymers are for instance polyimides and their copolymers, polyamides and related copolymers, polyesters, aromatic polyethers and their derivatives, benzimidazoles, and ladder polymers. It should be noted that there are lots of other heat resistant synthetically developed or commercially succeeded polymers (less important) that are not mentioned herein, all completely described in books and review papers published in this field, may also be used as the material for the disposable cartridge.

It is disclosed herein that according to some embodiments, the mousse could also be covered by a (thin) coating on the sides (partially or fully) to prevent fingers sticking to the cartridge when handling. This coating could be heat-resistant, but could also be volatile, and disappear when being heated. The coating (plastic or so layer) could be on the outer perimeter only. Alternatively, instead of a coating material, it can be a thin layer which can be removed before being used. For instance, such material could be a non-heat resistant paper and can be removed before heating.

In addition, the same material could be used in several densities. For example, the mousse could be relatively dense on the outside, while airier in the center. This will provide more stiffness for handling, while improving airflow through the rest

Apart from heat-resistant polymeric material, porous ceramics e.g. porous ceramic having pore diameter (d) more than 10 μm can be used as the material for the disposable cartridge. Generally, porous ceramics have good properties such as mechanical strength, abrasion resistance, chemical and thermal stability. These porous network ceramic structures also have relatively low density, low mass and low thermal conductivity. Disclosed herein is that the ceramic for example could be a cup shape (with hole in the bottom) to hold the mousse. Alternatively, the ceramic could also be very open pores such as to hold the aerosol and tobacco trapped inside the pores.

A further alternative material for the disposable cartridge can be loose, non-oriented fibres, where these fibres can be used to form not only the cartridge but also as a supporting structure for the content of the cartridge e.g. foam or mousse. Examples of the non-oriented fibres such as those describes in patent document EP 3039060 A1 are suitable to be used in the present invention. For example, the fibers could form a very open matrix that would be filled with mousse.

FIGS. 2a and 2b are a second embodiment of the present invention where the aerosol-generating article 100 in form of a cartridge is provided in form of a triangular shape, having an external wall 10 and an internal wall 20. A longitudinal channel 50 formed from the internal wall 20 which is parallel to the vertical axis Y of the cartridge is provided to the centre region of the cartridge, extending from the base 15 to the top 25 (not shown), as can be seen in the FIG. 2b.

FIGS. 3a, 3b and 3c show another variant of the aerosol-generating article 100 in form of other disposable shaped cartridge, where the longitudinal channel 50 has a funnel shape 15b at the bottom region 15 of the cartridge. This embodiment has the advantage that more heated air can flow in contact with the wall of the cartridge.

A further variant to the examples shown in FIGS. 3a-3c are illustrated in FIGS. 4a and 4b, where a ridge 15c is provided to the base 15 of the cartridge, encircling the rim of the funnel shape 15b which is provided to the bottom part 15 of the longitudinal channel 50.

Apart from the above-described benefits, these variants of the disposable shaped cartridge are particularly suitable to be used to complement with the surface area of the heat-generating element where bulges are present on the heat-generating element. In other words, these cartridges can be selected or designed accordingly to complement with the contour of the heat-generating element of the heating device such that an optimum surface contact there between can be achieved.

Moreover, it is disclosed herein that by providing the funnel shape 15b and the ridge 15c, the temperature of the heated air can be reduced such that lower temperature e.g. 250° C., which is optimal for tobacco foam or mousse can be achieved, thereby the aerosol-generating substrate contained within the cartridge can be optimally heated.

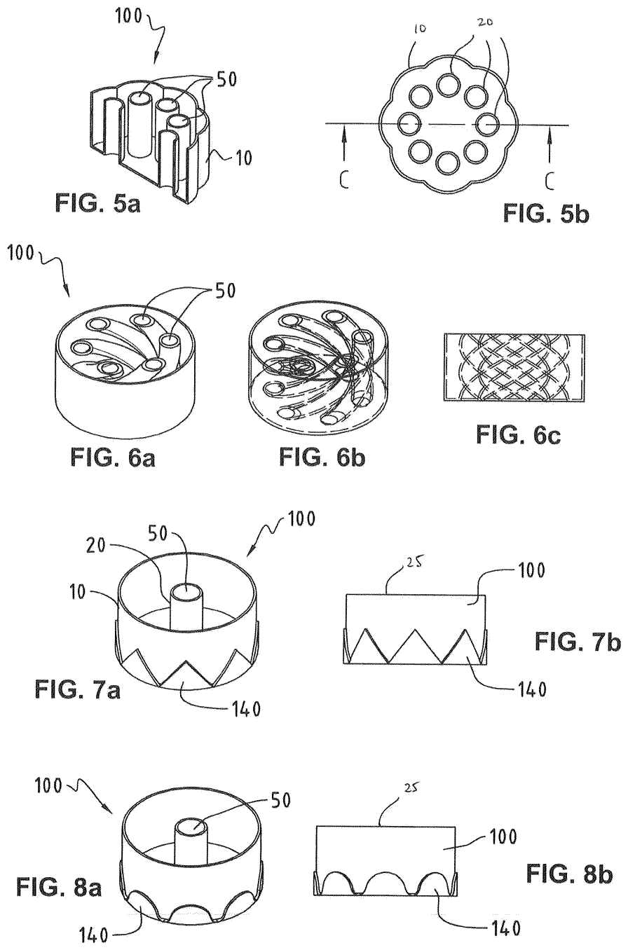

FIG. 5a shows that multiple longitudinal channels 50 can also be provided to the disposable shaped cartridge. In other words, multiple internal walls 20 can be provided to the cartridge, each forming a longitudinal channel 50. The multiple longitudinal channels serve to evacuate the vapour from the aerosol-generating article and device. This also allowed a more controlled vapour to flow through the cartridge. The openings of the channels are preferably from the base 15 to the top 25, however it is also possible to be provided at the wall 10.

Moreover, apart from a cylindrical, square, triangular or polygon shape cartridge, the outer wall 10 of the cartridge can also be provided in a flowery mosaic shape or irregular shape (c.f. FIG. 5b). The longitudinal channel 50 can be straight or spiral or entangled, as shown in the FIGS. 6a, 6b and 6c. In this embodiment, when the longitudinal channel 50 is spiral, heated air may reach more region of the cartridge such that a more homogenised and consistent aerosol can be produced, as the material within the cartridge can be heated more evenly.

It is reiterated herein that the base 15 as well as other sides of the cartridge may not only be flat, but also in other forms such as to match the surface profile of the heat-generating element 140 where they adjoin to each other. For example, the base, when viewed from a vertical section of the cartridge perpendicular to a horizontal axis of the cartridge, can have one or more of the following shapes: V, N, U, n, Λ and ω. FIGS. 7a and 7b show that for example the base of the cartridge may be provided with multiple “V”s and inverted “V”s which are matched to the surface profile of the heat-generating element 140, as shown the FIG. 7b. Similarly, the cartridge may be provided in multiple “U”s and inverted “U”s which are matched to the surface profile of the heat-generating element 140 of a heating device, as illustrated in the FIGS. 8a and 8b. By providing disposable shaped cartridges having surface profiles complementary to the surface profile of the heat-generating element 140, more contact surfaces are created, thereby allowing a denser, more consistent aerosol to be released.

To this end, it is noted that in some instances, the surface of the cartridge contacted with the heat-generating element 140 may be deformed during heating as a result of the used-up mousse e.g. part of the materials being vaporised. For this reason, a stiffer carrier matrix for use as the material of the cartridge explained above can be used to prevent the collapse of the cartridge.

Present invention aims to improve conveying of heat from a heater of a heating device to aerosol-generating tobacco-containing substrates e.g. tobacco mousse contained in a shaped cartridge. This objective is achieve through having for instance having higher contact surface at the bottom of the shaped cartridge or by providing one or more longitudinal channels within the shaped cartridge, wherein the longitudinal channels are shaped according to the shape of the heating element such that an optimum surface contact is achieved for an efficient heat transfer. Moreover, in some instances where the heating elements could not reach to the longitudinal channels of the shaped cartridge, heated air or aerosol generated from the heating element traveling through the longitudinal channels is capable of heating higher surface area of the aerosol-generating tobacco-containing substrate. These characteristics of the present invention allows a more homogenise heating of the aerosol-generating tobacco-containing substrates, thereby generating denser, more consistent aerosol from a single use and disposable consumable.

1. An aerosol-generating article in form of a shaped cartridge comprising a foamed aerosol-generating material, wherein the shaped cartridge is disposable and comprises a base, a top, an internal wall and an external wall, wherein the base and the top of the cartridge are connected to the internal wall and the external wall, wherein the internal wall delimits one or more longitudinal channels void of and extending through the foamed aerosol-generating material.

2. The aerosol-generating article according to claim 1, wherein the one or more longitudinal channels extend from the base of the cartridge to the top and/or to the external wall of the cartridge.

3. The aerosol-generating article according to claim 1, wherein the one or more longitudinal channels extend predominantly parallel to or about a longitudinal axis of the cartridge.

4. The aerosol-generating article according to claim 1, wherein the one or more longitudinal channels are configured to fit about a heat-generating element of a heating device.

5. The aerosol-generating article according to claim 1, wherein the one or more longitudinal channels are straight or spiral.

6. The aerosol-generating article according to claim 1, wherein the cross-section perpendicular to the longitudinal axis of the one or more longitudinal channels comprises a circular, edged, oval or irregular profile.

7. The aerosol-generating article according to claim 1, wherein the cross section perpendicular to the external wall of the cartridge has a circular, square, rectangular, triangular, ridge or spoke, polygon or an irregular shape.

8. The aerosol-generating article according to claim 1, wherein the base of the cartridge is substantially flat and/or edged such as to increase the contact points with a heat-generating element of a heating device.

9. The aerosol-generating article according to claim 1, wherein the base of the cartridge has a surface complimentary to a shape of a heat-generating element of a heating device such as to increase the contact points between the base and the heat-generating element for the transmission of heat to the cartridge.

10. The aerosol-generating article according to claim 1, wherein the cartridge is made of a material comprising temperature-resistant polymeric foam, porous ceramic or non-oriented fibres.

11. The aerosol-generating article according to claim 1, wherein one or more openings are provided to the cartridge for filling of materials such as the aerosol-generating tobacco-containing substrates and/or a carrier matrix.

12. The aerosol-generating article according to claim 1, wherein the shaped cartridge is air permeable and/or has a mesh structure.

13. The aerosol-generating article according to claim 1, wherein the cartridge has one or more individual compartments, wherein the compartments are filled with same or different materials, comprising aerosol-generating tobacco-containing substrate and/or a stiff carrier matrix.

14. The aerosol-generating article according to claim 1, wherein between 10% and 33-% of the total volume of the cartridge is comprised of the longitudinal channels which are void of the foamed aerosol-generating material.

15. A vaping system, comprising:
an aerosol-generating article according to claim 1; and
a vaping device comprising a heating-generating element fit within the one or more longitudinal channels within the cartridge.
